(19) United States
(12) Patent Application Publication
(10) Pub. No.: US 2008/0038996 A1
(43) Pub. Date: Feb. 14, 2008

(54) POLISHING COMPOSITION FOR SEMICONDUCTOR WAFER, PRODUCTION METHOD THEREOF, AND POLISHING METHOD

(75) Inventors: Kuniaki MAEJIMA, Tokyo (JP); Shinsuke MIYABE, Tokyo (JP); Masahiro IZUMI, Tokyo (JP); Hiroaki TANAKA, Kanagawa (JP); Makiko KURODA, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NIPPON CHEMICAL INDUSTRIAL CO., LTD., Tokyo (JP); SPEEDFAM CO., LTD., Kanagawa (JP)

(21) Appl. No.: 11/837,734

(22) Filed: Aug. 13, 2007

(30) Foreign Application Priority Data
Aug. 14, 2006 (JP) 2006-220897

(51) Int. Cl. B24B 7/00; C09K 3/14

(52) U.S. Cl. 451/37; 51/308

(57) ABSTRACT

A polishing composition for semiconductor wafers containing colloidal silica is disclosed, wherein the colloidal silica is prepared from an active silicic acid aqueous solution obtained by removing alkali from an alkali silicate aqueous solution and a quaternary ammonium base, and is stabilized with a quaternary ammonium base. The polishing composition contains no alkali metals. The polishing composition contains a buffer solution that is a combination of a weak acid having a pKa from 8.0 to 12.5 at 25° C. (pKa is a logarithm of the reciprocal of acid dissociation constant) and a quaternary ammonium base, and exhibits a buffer action in the range from pH8 to pH11.

### TECHNICAL FIELD

The present invention relates to a polishing composition for semiconductor wafers and a production method thereof. More specifically, the present invention relates to a polishing composition for semiconductor wafers used to polish the surface or edge of a semiconductor wafer, and a production method thereof. Furthermore, the present invention relates to a polishing method for allowing the surface and edge of a semiconductor wafer to have a mirror surface by using the polishing composition for semiconductor wafers. The semiconductor wafer that is subject to the polishing of the present invention includes preferably a silicon wafer and a semiconductor device substrate having a metal film, an oxide film, a nitride film, or others (hereinafter, called as metal film and others) formed on its surface.

### BACKGROUND ART

Electronic components such as ICs, LSIs and super LSIs using semiconductor materials such as single crystal silicon as raw material, are produced as follows: a single crystal ingot of silicon or the other compound semiconductors is sliced into thin disc wafers; a number of fine electronic circuits are built in the wafer; and then the wafer is broken up into small platelets of semiconductor element chips. The wafer that is produced by slicing the ingot is processed into a mirror surface wafer with a mirror-polished surface and edge through the steps of lapping, etching, and further polishing. After that, in a device-manufacturing step, fine electronic circuits are formed on the surface of the mirror-polished wafer. At present, from the viewpoint of developing high-speed LSIs, the process for forming the electronic circuits has been shifting to a new process. Specifically, in place of a conventional wiring material of Al, Cu having still lower electrical resistance than Al is used. A low dielectric film having a still lower dielectric constant than that of a silicon oxide film is used as an insulating film between wirings. Further, between Cu and the low dielectric film, a barrier layer of tantalum or tantalum nitride is interposed so as to prevent Cu from diffusing into the low dielectric film. In order to develop such wiring structure and high integration, polishing step is repeated many times in the process such as (a) planarizing interlayer insulation films, (b) forming metal interconnections (plugs) connecting the upper and lower of multilayer wirings, and (c) forming embedded wirings. In the polishing step, generally, a semiconductor wafer is put on a surface table having a polishing cloth of a synthetic resin foam, suede-like synthetic leather or the like extended and stretched thereon; while the semiconductor wafer is pressed against the surface table and rotated, a given amount of polishing composition solution is supplied so as to polish the semiconductor wafer.

At the edge of the semiconductor wafer, the above-mentioned metal film and others are unevenly deposited. Before broken up into semiconductor element chips, the wafer is supported at the edge when it is subject to a transportation step or the like, while keeping the initial disk shape. In the case where the edge of the wafer is unevenly structural shape at the transportation, micro cracks of the wafer is caused when the wafer comes into contact with a transporter, thereby developing fine particles sometimes. The fine particles developed are scattered in the subsequent steps, contaminating the finely-processed faces, largely influencing the yield and quality of products. To prevent the contamination caused by the fine particles, the edge of the semiconductor wafer is needed to have mirror-polishing after the metal and other films are deposited.

The edge is polished as follows: the edge of the semiconductor wafer is pressed against the face of a polishing member having a polishing cloth made of a synthetic resin foam, synthetic leather, nonwoven fabric or the like applied to the surface of a polishing cloth support; and then either of the polishing member and wafer is rotated while a polishing composition containing a polishing abrasive particles such as silica as a main ingredient is supplied. As the abrasive particles used here for the polishing composition, there has been proposed colloidal silica similar to the one used for silicon wafer edge polishing, fumed silica, ceria or alumina that is used for polishing of device wafer, and the like. Particularly, the colloidal silica and fumed silica have become a focus of attention because they are so fine that a flat mirror face can be easily formed. The polishing composition as mentioned above is called also as “slurry”, which may be called as such in some cases below.

The polishing composition containing the silica abrasive particles as a main ingredient is given as a solution that contains alkali components in general. The polishing mechanism can be described by the combination of chemical action by the alkali components, specifically chemical corrosion against the surface of silicon oxide film, metal films or the like, and mechanical abrasion by the silica abrasive particles. More specifically, the corrosion by the alkali components produces a thin and soft corrosion layer on the surface of an object product to be polished such as a wafer. It is estimated that the resulting corrosion layer is removed by the mechanical abrasion of the fine abrasive particles. It is considered that polishing may proceed by repeating these steps. After polishing, the silica abrasive particles and alkali components are removed from the surface and edge polished in a cleaning step.

A problem that the abrasive particles remain on the wafer surface in the cleaning step has been pointed out. It is possible to largely improve such a state that the abrasive particles remain on the wafer surface by selecting properly polishing conditions or cleaning processes. On the other hand, polishing speed is largely lowered and the cleaning process becomes complicated. The problem has not yet been solved.

Furthermore, fine-line processing for device wiring has become more pronounced year by year. According to International Technology Roadmap for Semiconductors, the aimed figures of the line width for device wiring are 90 nm for the year of 2004, 65 nm for 2007, 50 nm for 2010, and 35 nm for 2013. As the line width of device wiring becomes finer, the semiconductor wafer surface after polishing is required to have still higher cleanness. The abrasive used for polishing the semiconductor wafer contains abrasive particles having a particle diameter of dozens of nanometers as mentioned above. So far, the diameter of the abrasive particles has been sufficiently smaller as compared with the line width, so that the abrasive particles remained on the semiconductor wafer surface have not posed a large problem. However, with the advancement of finer-line device wiring, the diameter of the abrasive particles has become almost the same as the line width of device wiring, and thus the abrasive particles remained on the semiconductor wafer surface have lead to malfunction of devices. This poses a serious problem.

Conventionally, various polishing compositions have been proposed for mirror polishing of semiconductor wafers. For example, U.S. Pat. No. 4,671,851 discloses colloidal silica containing sodium carbonate and an oxidizing agent. EP0357205A1 discloses colloidal silica containing ethylenediamine. JP11-60232A discloses silica particles having a shape of cocoon. JP6-53313 discloses a method for polishing device wafers using an aqueous solution containing ethylenediamine pyrocatechol and silica fine powder. JP8-83780 discloses a method for polishing semiconductor wafers using an aqueous solution containing glycine, hydrogen peroxide, benzotriazole, and silica fine powder. U.S. Pat. No. 5,904,159 discloses an abrasive obtained by dispersing fumed silica having an average diameter from 5 to 30 nm in a KOH aqueous solution, and a method for producing the abrasive. U.S. Pat. No. 5,230,833A discloses polishing slurry of colloidal silica from which sodium is removed by cation exchange. The addition of an amine as a polishing promoter into the polishing slurry is proposed, and also the addition of a quaternary ammonium salt as a bactericide is proposed. JP2002-105440 discloses the use of a specific amine. JP2003-89786 discloses high-purity colloidal silica for polishing that is prepared using tetramethylammonium hydroxide in place of sodium hydroxide as an alkali agent used in the step of growing colloidal silica particles, and is substantially free of sodium. U.S. Pat. No. 6,300,249B1 discloses a silicon oxide colloid solution that is prepared as a buffer solution having a buffering action in the range of pH8.7 to pH 10.6 by adding any one of combinations selected from weak acid and strong base, and weak acid and weak base. U.S. Pat. No. 6,238,272B1 discloses a polishing composition admixed with an alkali component and an acid component to have a buffering action, and using quaternary ammonium as the alkali component.

When colloidal silica is used in a manner as disclosed in U.S. Pat. No. 4,671,851 and EP0357205A1, there is a problem of impurity. Because sodium silicate is used as raw material for the production of the colloidal silica, relatively large amounts of alkali metals such as sodium are incorporated in the colloidal silica obtained. Therefore, the abrasive particles of the colloidal silica tend to be left behind after polishing. The silica particles having the shape of cocoon as disclosed in JP11-60232A have high purity and are excellent in terms of containing no alkali metals, since the silica particles are prepared using an organic silicon compound as raw material. However, these silica particles are soft and have a disadvantage of slow polishing speed. The methods disclosed in JP6-53313A and JP8-83780A are excellent in terms of containing no alkali metals. However, fumed silica is considered to be used because these documents describe that silica fine powder is used. The filmed silica can bring a high polishing speed, but may be easy to develop scratches on the polished face. U.S. Pat. No. 5,904,159A discloses fumed silica slurry, which may provide a high polishing speed, but easily develop scratches. In addition, a KOH aqueous solution is used for the slurry, so that the slurry is not appropriate as a polishing material. The low-sodium content colloidal silica described in U.S. Pat. No. 5,230,833A is admixed with an amine as a polishing promoter and a little amount of a quaternary ammonium salt as a disinfectant having a polishing promoting effect as well. In the example, as the amine, aminoethylethanolamine and piperazine are disclosed. Recent years, it has been found that amine causes metal contamination in wafers, particularly copper contamination owing to the metal chelating action of amine. Further, U.S. Pat. No. 5,230,833A describes that KOH is used for pH control, so that the problem to be solved is the reduction of sodium content. JP2002-105440A describes the risks of wafer contamination caused by aminoethylethanolamine. The colloidal silica described in JP2003-89786A contains no sodium in the water phase and the surface and the inside of the particles, and, therefore, it is an extremely desirable abrasive. However, pH fluctuation during polishing is large when using quaternary ammonium hydroxide alone, and also the pH may be lowered largely by the atmospheric carbon dioxide, and thus a stable polishing speed may not be attained.

If comparisons are made with edge polishing and surface polishing of semiconductor wafers, the former has a shorter time of contacting a polishing cloth to the polishing surface than the latter, so that the pressure applied to the polishing surface of the edge is made to be higher and the linear velocity of the polishing cloth with respect to the polishing surface is made to be higher. Namely, the edge is polished under extremely harsh conditions as compared with the surface. The edge of semiconductor wafers has an extremely large surface roughness. Under such process conditions, conventional compositions containing fumed silica for polishing the surface of semiconductor wafers hardly provide sufficient polishing speed and surface roughness.

### SUMMARY OF THE INVENTION

A first invention of the present invention provides a polishing composition for a semiconductor wafer comprising: a colloidal silica being prepared from an active silicic acid aqueous solution obtained by removing alkali from an alkali silicate aqueous solution, and a quaternary ammonium base, and being stabilized with a quaternary ammonium base; and a buffer solution which is a combination of a weak acid having a pKa that is a logarithm of a reciprocal of acid dissociation constant of from 8.0 to 12.5 at 25° C. and a quaternary ammonium base, wherein the polishing composition contains substantially no alkali metals, and has a buffer action at 25° C. in the range from pH8 to pH11.

The colloidal silica stabilized with a quaternary ammonium base preferably contains non-spherical silica particles.

The polishing composition is preferably a water dispersion having a silica concentration from 2 to 50% by weight with respect to a total amount of a colloidal solution.

Further, the polishing composition preferably has a conductivity at 25° C. of 15 mS/m or more based on 1% by weight of silica particles.

The polishing composition preferably has a salt of a strong acid and a quaternary ammonium base so as to adjust the conductivity at 25° C. of 15 mS/m or more based on 1% by weight of silica particles.

The salt of a strong acid and a quaternary ammonium base is preferably a quaternary ammonium sulfate, a quaternary ammonium nitrate, or a quaternary ammonium fluoride.

The anion constituting the aforementioned weak acid is preferably a carbonate ion and/or a hydrogen carbonate ion, and the quaternary ammonium base is preferably a choline ion, a tetramethylammonium ion or a tetraethylammonium ion, or a mixture thereof. “Choline” is a popular name of trimethyl (hydroxyethyl) ammonium.

Further, an average diameter of silica particles of the colloidal silica in the polishing composition for a semiconductor wafer by a BET is preferably from 10 nm to 200 nm.

A second invention of the present invention provides a method for producing the polishing composition for a semiconductor wafer described above, comprising the steps of: preparing the active silicic acid aqueous solution by contacting dilute sodium silicate with a cation exchange resin to remove sodium ions; allowing to grow colloidal particles by adding the quaternary ammonium base to adjust the pH in the range from 8 to 11 followed by heating the active silicic acid aqueous solution; preparing the colloidal silica which is free of alkali metals and has a silica concentration from 10 to 60 wt % by concentrating silica with ultrafiltration; and adding the weak acid and the quaternary ammonium base to the colloidal silica to make a buffer composition and to adjust the silica concentration in the range from 2 to 50 wt %.

A third invention of the present invention provides a polishing method comprising: rotating a rotatable surface table and/or a semiconductor wafer while the polishing composition described above is supplied to the surface table to polish a surface of the semiconductor wafer using the surface table having a polishing cloth fixed to both or either of its upper and lower face, under a state of the semiconductor wafer being pressed against the surface table.

A fourth invention of the present invention provides a polishing method comprising: polishing an edge of a semiconductor wafer using a drum-shaped polishing member having a polishing cloth fixed to its surface or with a polishing apparatus having a polishing member with an arc-shaped working surface, wherein the polishing member and/or a semiconductor wafer are rotated while the polishing composition described above is supplied to the polishing member, under a state of the edge of the semiconductor wafer being pressed against the polishing member.

### BRIEF DESCRIPTION OF THE DRAWINGS

FIG. 1 shows a TEM image of colloidal silica of the present invention obtained in the examples.

FIG. 2 shows a TEM image of colloidal silica used in the comparative example.

### DETAILED DESCRIPTION OF THE INVENTION

The present invention is to provide a polishing composition that suppresses remaining abrasive particles on the surface of a semiconductor wafer, keeps a high polishing speed, and allows the surface and edge of the semiconductor wafer to attain a mirror surface with a good roughness, and a production method thereof. Further, the present invention is to provide a polishing method for allowing the surface and edge of a semiconductor wafer to have a mirror surface, using the polishing composition.

The present inventors have found that the surface and edge of a semiconductor wafer can be mirror-polished effectively by using a polishing composition for a semiconductor wafer comprising a colloidal silica stabilized with a quaternary ammonium base, and a buffer solution which is a combination of a weak acid having a pKa that is a logarithm of a reciprocal of acid dissociation constant of from 8.0 to 12.5 at 25° C. and a quaternary ammonium base, wherein the polishing composition contains substantially no alkali metals, and has a buffer action at 25° C. in the range from pH8 to pH11. Thus, the present invention has been accomplished based on this finding.

The polishing composition of the present invention provides such a remarkable effect that particle contamination, particularly remains of abrasive particles (hereinafter, described as “abrasive remains”) on a surface portion in polishing a semiconductor wafer and the like is not easy to take place. “Abrasive remains” represents such a state that abrasive particles of a polishing composition adhere to a surface portion of a wafer during polishing, and the abrasive particles are left behind on the surface portion of the wafer even after cleaning. The present invention overcomes the problem of abrasive remains at the surface portion, for which countermeasures have been comparatively insufficiently taken so far. The present invention provides a polishing composition that exhibits an excellent polishing performance for mirror-polishing of wafers and a stability of the polishing performance. In this way, the present invention provides an extremely large effect on the related technology fields.

It is quite important that the polishing composition of the present invention contains substantially no alkali metals in the water phase and the surface and the inside of silica particles, and is composed of colloidal silica stabilized with a quaternary ammonium base. Commercially-available colloidal silica stabilized with sodium contains generally 20 to 50 wt % of silica (SiO₂) and 0.1 to 0.3 wt % of Na₂O (0.07 to 0.22 wt % in terms of Na). The content of sodium is from 0.2 to 0.7 wt % expressed in terms of silica. Generally, colloidal silica having a larger particle diameter has lower sodium content.

Here, there is briefly mentioned about “stabilization”. For example, silica particles dispersed in pure water have silanol groups on their surface, and the outside of the particles is surrounded only by water molecules. The particles vibrate and move by Brownian motion, so that they collide with one another and are linked together through dehydration bonding between the silanol groups. As the linkage expands, the colloid has increased viscosity, and eventually turns into a gel. For example, silica particles dispersed in a dilute sodium hydroxide aqueous solution at about pH9 have silanol groups on their surface, and there exist hydrated sodium cations outside of the silanol groups. Thus, the particles are charged in anionic. On the outside of the hydrated phase of the sodium cations, there exist OH⁻ ions closely, and further on the outside thereof there exist water molecules. The silica particle surface having such a restraint phase as described above provides repulsion among the particles, so that collision and linking among particles is inhibited. This state is called as “stabilization”.

The colloidal silica stabilized with sodium hydroxide contains sodium in the water phase and the surface and the inside of the silica particles. The content of sodium inside of the silica particles is from 0.1 to 0.5 wt % based on silica. The sodium contained in the water phase and the surface of the silica particles can be removed by contacting the colloidal silica with a proton-type cation exchange resin. However, the sodium inside of the silica particles partly migrates to the surface of the particles by degrees taking several-months period at normal temperature, and this migration may be detected as a pH change. As a result, the water phase and surface of the silica particles hold sodium again.

The colloidal silica stabilized with a quaternary ammonium base as in the present invention contains sodium in very small quantity. As mentioned later, in the preferred production method of the present invention, sodium silicate is contacted with a cation exchange resin to remove sodium ion thereby to prepare an active silicic acid aqueous solution. However, sodium ion is not completely removed, and the resulting active silicic acid aqueous solution contains sodium ion in very small quantity. Generally, the amount of the sodium ion is 50 ppm or less by weight based on silica. Such a small amount of sodium is acceptable in the present invention. In the present invention, “substantially contains no alkali metals” is used in this meaning.

The present inventors are the first who have found that silica particles of colloidal silica stabilized with a quaternary ammonium base wherein sodium in the water phase and the surface of the silica particles is removed are not easy to adhere to the wafer surface. The mechanism can be speculated as follows. In the case of the colloidal silica stabilized with sodium hydroxide, water is slightly evaporated during the passage of a little time while polishing slurry is on the surface of a wafer after polishing, whereby sodium hydroxide corrodes the silica particles and the metal (or metal oxide) surface of the wafer, and the silica particles and metal hydroxide are bonded together. It is considered that the bonding may be caused by fusing the silica particle surface and metal hydroxide surface or by electrostatic interaction between the minus charge of the silica and the plus charge of the metal hydroxide surface.

On the other hand, in the case of the colloidal silica stabilized with a quaternary ammonium base, quaternary ammonium ions exist on the surface of silica particles and on the surface of a wafer as well. On both surfaces, the alkyl groups of the quaternary ammonium ions are exposed to the outside. The repulsion among these alkyl groups prevents the silica particles from adhering to the wafer surface. In the field of metal corrosion inhibition, quaternary ammonium bases and amines are used as an inhibitor (corrosion inhibitor). The nitrogen atom of the inhibitor molecule adsorbs to the metal surface, and the alkyl group of the molecule direct to the liquid phase so as to form a water-repellent phase on the metal surface, which is considered to exert corrosion inhibition effect. Similar corrosion inhibition effect may be considered to exert on the wafer surface.

The quaternary ammonium base is preferably, for example, choline ion, tetramethylammonium ion, tetraethylammonium ion, or a mixture thereof. The other preferable quaternary ammonium base may include a quaternary ammonium ion composed of an alkyl group having 4 or less carbon atoms or a hydroxyalkyl group having 4 or less carbon atoms. The alkyl group may include, for example, a methyl group, an ethyl group, a propyl group and a butyl group. The hydroxyalkyl group may include, for example, a hydroxymethyl group, a hydroxyethyl group, a hydroxypropyl group and a hydroxybutyl group. Specifically, tetrapropylammonium ion, tetrabutylammonium ion, methyltrihydroxyethylammonium ion, triethyl (hydroxyethyl) ammonium ion or the like is preferable, because they are easily available.

Further, the other preferable quaternary ammonium bases may also include benzyltrimethylammonium ion, phenyltrimethylammonium ion and the like, which are also easily available.

Depending on their organic groups, quaternary ammonium bases change their performances of corrosion and polishing against wafers and also change their cleaning performance of the abrasive particles. Therefore, preferably these may be appropriately selected on use. Two or more of them may be used preferably in combination.

The polishing composition of the present invention preferably keeps its pH within a range from 8 to 11 at 25° C. as a whole composition in order to maintain the stable polishing performance at the actual polishing process. At a pH lower than 8, polishing speed is lowered and sometimes goes out of the practical range. At a pH is higher than 11, etching rate tends to become too high at portions other than the polishing portions. In addition, silica particles possibly start to aggregate and, thereby the stability of the polishing composition becomes lowered and sometimes goes out of the practical range.

It is preferable that the pH as a whole composition is not easy to fluctuate by possible external conditions such as friction, heat, contact to the outside air, and mixing with the other components. Particularly in the case of polishing the edge of a semiconductor wafer, the polishing composition is preferably circulated on use. That is, the polishing composition supplied to the polishing portions from a slurry tank is circulated back to the slurry tank. The polishing composition containing only alkaline agents lowers its pH in a short period of time on use because of the dissolution of the portions to be polished or mixing of cleaning water. The variation of the polishing speed caused by the pH fluctuation possibly results in poor polishing or adversely results in overpolishing caused by excessive polishing.

In order to keep the polishing composition of the present invention at a constant pH, the polishing composition of the present composition preferably has a buffer solution composition that is given by a combination of a weak acid having a pKa from 8.0 to 12.5 at 25° C. (pKa is a logarithm of the reciprocal of acid dissociation constant) and a quaternary ammonium strong base. In this case, it is preferred that the buffer action exert in the range from pH8 to pH11 at 25° C. The buffer action within the range from pH8 to pH11 means that the pH of the polishing composition of the present invention is in the range from pH8 to pH11 after the composition is diluted 100 times with water.

The anion that forms the weak acid in the buffer solution is preferably carbonate ion and/or hydrogen carbonate ion. In addition to that, the cation that forms the quaternary ammonium strong base is preferably at least one kind selected from choline ion, tetramethylammonium ion and tetraethylammonium ion. The other quaternary ammonium ion described above may also be used.

In the present invention, it is preferred that the polishing composition itself is a solution with a strong buffer action that has a little change in pH against fluctuation in the outside conditions. The buffer solution may be prepared by using a weak acid having a pKa from 8.0 to 12.5 at 25° C. (pKa is a logarithm of the reciprocal of acid dissociation constant, Ka) and a quaternary ammonium strong base in combination as described above. When the logarithm (pKa) of the reciprocal of the acid dissociation constant at 25° C. is less than 8.0, a large quantity of a weak acid and a strong base is undesirably required to elevate the pH. When the logarithm (pKa) of the reciprocal of the acid dissociation constant at 25° C. is larger than 12.5, a buffer solution having a stable and strong buffer action in the range from pH8 to pH11 is not easily formed and thus undesirable.

In the present invention, as the weak acid used to prepare the polishing composition having buffer action, there may be mentioned preferably, for example, carbonic acid (pKa=6.35 and 10.33). Besides these, there may be mentioned boric acid (pKa=9.24), phosphoric acid (pKa=2.15, 7.20 and 12.35), a water-soluble organic acid, and others. A mixture of these acids may also be used. As the strong base, there may be used a quaternary ammonium base hydroxide. The buffer solution of the present invention is a solution given by the combination described above. In the buffer solution, the weak acid is dissociated into ions having different valences, or the weak acid exists both in dissociated and undissociated states. The buffer solution has such a characteristic property that the pH changes by only a little when a small amount of acid or base is mixed.

In the present invention, polishing speed can be remarkably improved by increasing the conductivity of the polishing composition. The conductivity is a measure of an ability to conduct an electric current through a liquid and is represented by the reciprocal of electrical resistivity. In the present invention, the conductivity is represented by converting the value (milli-Siemens) into the value based on 1 wt % of silica. In the present invention, a conductivity of 15 mS/m1%-SiO₂ or more at 25° C. is preferable for improving the polishing speed, and a conductivity of 20 mS/m/1%-SiO₂ or more is especially preferable. The upper limit of the conductivity differs depending on the diameter of the silica particles, but is around 60 mS/m/1%-SiO₂.

The polishing process using the polishing composition of the present composition involves application of the chemical action of the alkali components of the polishing composition, specifically the corrosive property of the alkali components against the product to be polished including a silicon oxide film and a metal film. Namely, owing to the corrosive property of alkalis, a corroded thin layer is formed on the surface of the product to be polished such as a wafer. The process proceeds by removing the thin layer with the mechanical action of the fine abrasive particles. The corrosion of the metal film is an oxidation reaction of metal: that is, electrons are transferred to the metal surface from the solution in contact with the metal surface; and the metal is dissolved into the solution in the form of a metal hydroxide ion. In order to allow the electrons to transfer swiftly, it is desirable that the conductivity of the solution be high.

There may be two methods for improving the conductivity. In one method, the concentration of the buffer solution is increased. In the other method, salts are added. These two methods may be used in combination.

The concentration of the buffer solution may be increased by increasing only the concentrations of the acid and base while keeping their molar ratio unchanged.

The salts used in the method of adding salts are composed of a combination of acid and base. The addition of salts lowers the stability of the colloid, so that there may be a limitation on the addition. Any acid may be used, including a strong acid and a weak acid. A mineral acid, an organic acid, or a mixture thereof may be used. As the base, there may be used preferably a water-soluble quaternary ammonium base hydroxide. The addition of a salt of weak acid and strong base, a salt of strong acid and weak base, or a salt of weak acid and weak base may possibly is change the pH of the buffer solution, so that the addition in large quantity is not desirable.

The salt of strong acid and quaternary ammonium base is preferably at least one kind selected from quaternary ammonium sulfate, quaternary ammonium nitrate, and quaternary ammonium fluoride. The cation that forms the quaternary ammonium strong base is preferably at least one kind selected from choline ion, tetramethylammonium ion, or tetraethylammonium ion. As the other quaternary ammonium ion, there may be used the one described above.

In the polishing composition of the present invention, the silica particles of the colloidal silica have a BET average diameter from 10 to 200 nm, and particularly preferably from 10 to 120 nm. The BET average diameter is an average primary diameter of particles that is obtained as follows: the specific surface area of the powdered colloidal silica is measured by the BET method with N₂-gas adsorption; and then the average primary diameter on the assumption that the particles are spherical is calculated based on the following equation from the specific surface area.

2720/specific surface area (m²/g)=average primary diameter (nm) of particles on the assumption that the particles are spherical.

It is also desirable that the polishing composition of the present invention contains a chelating agent capable of forming a water-insoluble chelate compound of copper. The preferable chelating agent may include, for example, azoles such as benzotriazole and quinoline derivatives such as quinolinol and quinaldic acid. As described above, a chelating agent such as ethanol amine that forms a water-soluble chelate compound of copper is not desirable.

The polishing composition of the present invention may be admixed with a surfactant, a dispersant, a defoaming agent, an anti-sediment agent, and others so as to improve the properties thereof. As the surfactant, dispersant, defoaming agent, and anti-sediment agent, there may be mentioned water-soluble organic substances, inorganic layered compounds, and others. Although the polishing composition of the present invention is an aqueous solution, there may be admixed with an organic solvent. The polishing composition of the present invention may be used by admixing with the other abrasives such as colloidal alumina, colloidal ceria, and colloidal zirconia, bases, additives, water, and others when polishing is performed.

In the subsequent description, the production method of the polishing composition according to the present invention containing colloidal silica stabilized with a quaternary ammonium base will be mentioned. Firstly, as an alkali silicate aqueous solution used as raw material, a sodium silicate aqueous solution, conventionally called as water glass (JIS No. 1 to 4 water glass or the like), is preferably used. The water glass is relatively inexpensive and easily available. Considering polishing semiconductor products incompatible with sodium ions, a potassium silicate aqueous solution is also suitable for the raw material. The alkali silicate aqueous solution may be prepared also by dissolving solid alkali metasilicate in water Alkali metasilicate is produced by way of crystallization, so that an alkali silicate with reduced impurities is available. The alkali silicate aqueous solution may be diluted with water if necessary.

An alkali silicate aqueous solution diluted with water is contacted with a cation exchange resin to prepare an active silicic acid aqueous solution. As the cation exchange resin used in the present invention, there may be selected a known resin as appropriate, but there is no particular limitation. The contacting process of the alkali silicate aqueous solution and the cation exchange resin is, for example, as follows: an alkali silicate aqueous solution is diluted with water to obtain a solution having a silica concentration from 3 to 10 wt %; the solution is contacted with a H-type strong acid cation exchange resin to be dealkalized; and then, if necessary, the solution is contacted with an OH-type strong basic anion exchange resin to be deanionized. In this way, an active silicic acid aqueous solution is prepared. Various proposals have made on the details of the contacting conditions so far. Any disclosed conditions may be adaptable to the present invention.

Then, a process for allowing to grow colloid particles is performed. In this growing process, a quaternary ammonium base is employed in place of an alkali metal hydroxide conventionally used. As the quaternary ammonium base, there may be used the ones described above. The growing process proceeds in accordance with conventional processes: for example, in order to allowing to grow the colloid particles, a quaternary ammonium base is added to the active silicic acid aqueous solution to adjust the pH at 8 to 11 at 25° C., and then the temperature is elevated to 60 to 240° C. In the case where the temperature is elevated to 100° C. or more, hydrothermal treatment using an autoclave is employed. The higher the temperature is, the larger the diameter of the particles obtained is. In addition, a buildup process may be employed. That is, a quaternary ammonium base is added to a part of the active silicic acid aqueous solution to adjust the pH within 8 to 11 at 25° C., the temperature is elevated to 60 to 240° C. to form seed sol, and then the residual active silicic acid is added to the seed sol. The build-up process is generally performed at 80 to 100° C. under an atmospheric pressure. In either of these methods employed, the growing process is performed so as to result in the silica particles being grown into 10 to 200 nm in diameter The dispersion state of the particles may be mono-dispersed or secondary aggregated. The dispersion state of the particles may be selected as appropriate depending on applications. The particles may be spherical or non-spherical. The shape of the particles may be selected as appropriate depending on applications. As opposed to conventional production methods using alkali metal hydroxide, non-spherical particles can be easily produced by the particle-growing process using a quaternary ammonium base.

Next, the resulting silica is concentrated. Evaporative concentration of water may be employed, but concentration by ultrafiltration is more advantageous in terms of energy efficiency.

An ultrafiltration membrane used for concentrating silica by ultrafiltration is explained. Separation using the ultrafiltration membrane is applied to the particles having a diameter from 1 nm to several microns. The ultrafiltration membrane is also applied to the separation of dissolved polymer substances. When the size of the particles to be separated is in the order of nanometers, filtration accuracy is represented in terms of fractionation molecular weight. In the present invention, an ultrafiltration membrane having a fractionation molecular weight of 15,000 or less may be suitably used. With a membrane specified in the above range, particles having a diameter of 1 nm or more can be separated. More preferably, an ultrafiltration membrane having a fractionation molecular weight of from 3,000 to 15,000 is used. For a membrane having a fractionation molecular weight of less than 3,000, the filtration resistance becomes too high and the filtration time becomes longer. Therefore, this is uneconomical. When the fractionation molecular weight exceeds 15,000, the filtration accuracy lowers. The membrane may be made of polysulfone, polyacrylonitrile, sintered metals, ceramics, or carbon. Any material may be used, but a membrane made of polysulfone is easy to use in view of heat resistance and filtration speed. The membrane may have any shape including spiral, tubular, hollow fiber and the like, but a hollow fiber membrane is compact in size and easy to use. Further, when metal impurities are washed out and removed by the same ultrafiltration process, if necessary, an additional operation, such as further washing out and removing with adding pure water even after an aimed concentration is obtained, can be performed in order to improve the removal rate. In the course of this process, the silica is concentrated to preferably from 10 to 60 wt %, and particularly from 20 to 50 wt %.

Still further, before or after the ultrafiltration, if necessary, purification with ion exchange resins may be added. For example, by contacting with an H-type strong acid cation exchange resin, impure metals and alkali metals that contamiante in the particle-growing process may be removed. Through deanionization purification performed by contacting with an OH-type strong basic anion exchange resin, still higher purity may be attained.

In this way, high-purity colloidal silica having a silica particle diameter from 10 to 200 nm and a silica concentration from 10 to 60 wt % is obtained.

Then, the resulting colloidal silica is admixed with a buffer solution, which is a combination of a weak acid having a pKa from 8.0 to 12.5 at 25° C. (pKa is a logarithm of the reciprocal of acid dissociation constant) and a quaternary ammonium base, to obtain the polishing composition of the present invention. The amount of the buffer solution admixed is such an amount to make the pH of the polishing composition from 8 to 11 at 25° C. and to provide buffer action in the range from pH8 to pH11.

The polishing composition of the present invention thus obtained is preferably a water dispersion having a silica concentration from 2 to 50 wt % with respect to the total amount of the composition. From the viewpoint of still improving the polishing performance of the polishing composition, the silica concentration is desirably from 10 to 25 wt %.

As mentioned above, in the production method of the polishing composition of the present invention, colloidal silica having a silica concentration from 10 to 60 wt % is prepared; and then the aforementioned buffer solution is added to the colloidal silica to adjust the pH as well as silica concentration. Further, in order to adjust the silica concentration and/or conductivity in the polishing composition of the present invention, an aqueous solution of the aforementioned salts may be added. In addition, it is desirable that deionized water and others be optionally added as appropriate to obtain the polishing composition of the present invention.

The polishing process for semiconductor wafers using the polishing composition of the present invention will be mentioned. In the case of surface polishing, the surface of a semiconductor wafer is polished as follows: under a state of the surface to be polished of the semiconductor wafer being pressed against a rotatable surface table, both or either of the surface table and semiconductor wafer are rotated while the polishing composition of the present invention is quantitatively supplied. The rotatable surface table has a polishing cloth applied to both or either of upper and lower faces thereof. A polishing machine is used for this process. As the polishing cloth, for example, there may be used a synthetic resin foam or suede-like synthetic leather. As the polishing machine used in the present invention, there may be mentioned, for example, SH-24 single side polisher and FAM-20B double side polisher manufactured by SPEEDFAM Co., Ltd.

In the case of edge polishing, generally, the edge of a semiconductor wafer is polished as follows: a work (an object product to be polished), that is a beveled (chamfered) semiconductor wafer, is pressed against a polishing member, while the edge of the wafer is inclined and the wafer is rotated, with the polishing composition being supplied. The polishing member is composed of a polishing cloth made of synthetic resin foam, synthetic leather, nonwoven fabric or the like that is applied on the surface of a rotatable support. An edge polishing machine is used for this process. As the edge polishing machine used in the present invention, there may be mentioned, for example, EP-IV edge polisher manufactured by SPEEDFAM Co., Ltd. The edge-polishing machine is equipped with a rotatable support having a polishing cloth applied on the surface thereof, and a rotatable holder that can clamp the work and be inclined at a desired angle. Both or either of the work and the support are rotated, while the edge of the work clamped by the holder is pressed against the support, with supplying the polishing composition of the present invention to mirror-polish the edge of the work. More specifically, polishing is carried out as: the edge of the rotating work is pressed at a given angle against the support having a polishing cloth and changing gradually its position by moving upward or downward; and the polishing composition of the present invention is dropped to the portion to be polished. The polishing process of semiconductor wafers using the polishing composition of the present invention will be described in detail in the following examples. Note that, the polishing machine is not limited to the above-mentioned machines, but any machine that is described in, for example, Japanese Patent Laid-Open Publication No. 2000-317788, Japanese Patent Laid-Open Publication No. 2002-36079, and others may be used.

A polishing composition for semiconductor wafers of the present invention and a polishing process using the polishing composition will be further described in detail with reference to the following example and comparative example, but it should be construed that the invention is in no way limited to those examples.

### EXAMPLE

### (1) Production Example of Colloidal Silica Raw Material-A

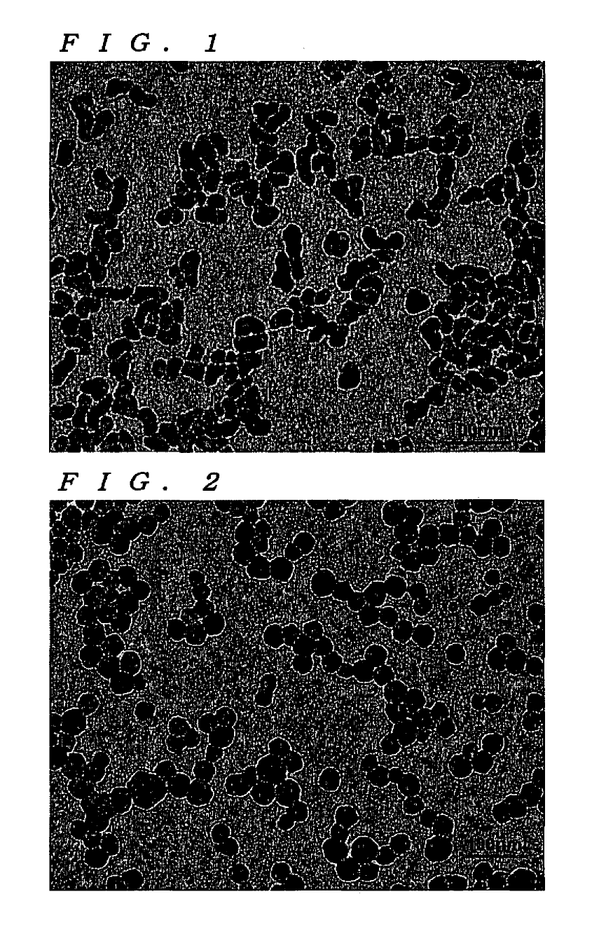

A dilute soda-silicate having a silica concentrated of 4.5 wt % was prepared by adding 520 kg of JIS No. 3 soda-silicate (SiO₂: 28.8 wt %, Na₂O: 9.7 wt %, H₂O: 61.5 wt %) to 2810 kg of deionized water and uniformly mixing them. The dilute soda-silicate was dealkalized by passing it through a 1,000-liter column of a H-type strong acid cation exchange resin (AMBERLITE IR120B manufactured by ORGANO Corp.) that was preliminary regenerated with hydrochloric acid. In this way, 3800 kg of an active silicic acid having a pH of 2.9 and a silica concentration of 3.7 wt % were obtained. The Na and K contents based on silica in the active silicic acid were 80 ppm and 5 ppm, respectively. After that, colloid particles were grown by the build-up process. To the part (580 kg) of the active silicic acid thus obtained, a 20 wt % tetramethylammonium hydroxide aqueous solution was added with stirring to adjust the pH at 8.7, and then the mixture was kept at 95° C. for 1 hour to prepare seed sol. To the resultant seed sol, the remaining active silicic acid, 3,220 kg, were added over 6 hours. During the addition, the pH was kept at 10 by adding a 20 wt % tetramethylammonium hydroxide aqueous solution. The temperature was also kept at 95° C. After the addition, the resulting reaction product was aged at 95° C. for 1 hour, and left to cool. The reaction product was filtered off under pressure using a hollow fiber ultrafiltration membrane having a fractionation molecular weight of 6,000 (MICROZA UF Module SIP-1013 manufactured by ASAHI KASEI Corp.) while the reaction product was circulated with a liquid circulation pump. In this way, the reaction product was concentrated to 31 wt % of silica concentration to obtain about 475 kg of colloidal silica. The silica particle diameter of the colloidal silica was 15 nm, and the Na and K contents based on silica were 13 ppm and 1.2 ppm, respectively. FIG. 1 shows the TEM image of the colloidal silica. The silica particles shown in FIG. 1 are a mixture of spherical particles and non-spherical particles having a “oval” or a “V-formation” in which several spherical particles linked together. The short axis of the colloidal silica particles was about 20 nm and the long axis was as large as about 50 nm from the TEM image.

### (2) Production Example of Additive-A (Salt Aqueous Solution)

To 37.5 kg of pure water, 37.5 kg of 95 wt % sulfuric acid were added to prepare 75 kg of dilute sulfuric acid. To the dilute sulfuric acid, 265 kg of a 25 wt % of tetramethylammonium hydroxide aqueous solution were dropped to neutralize at pH7 thereby to prepare 340 kg of a tetramethylammonium sulfate aqueous solution. Additive-A is an additive agent to increase the conductivity.

### (3) Production Example of Additive-B (Buffer Solution)

Carbon dioxide gas was blown into 164 kg of a 25 wt % tetramethylammonium hydroxide aqueous solution under vigorous agitation to neutralize the aqueous solution at pH8.4 thereby to obtain 184.2 kg of a 33 wt % tetramethylammonium hydrogen carbonate aqueous solution. To the foregoing aqueous solution, 149.1 kg of a 25 wt % tetramethylammonium hydroxide aqueous solution were admixed to prepare 333.3 kg of a mixed tetramethylammonium solution used as a buffer solution. In additive-B, tetramethylammonium hydrogen carbonate is a salt composed of a combination of a weak acid of carbonic acid (pKa=10.33) and a strong base, so that the additive-B serves as the buffer solution in the present invention.

### (4) Preparation of Colloidal Silica with pH Buffer Composition

To 17 kg of the colloidal silica prepared as described above, the additive-A and additive-B each were added in an amount shown in Table 1, and then they were mixed for 24 hours. In this way, a colloidal silica having a pH buffer action and a silica concentration of 30 wt % was prepared. The properties of three kinds of colloidal silica, abbreviated as C-1, C-2 and C-3, respectively, are shown in Table 1. In Table 1, “Total Na concentration (ppm/SiO₂)” denotes the sodium concentration based on silica. Further, in the table, the conductivity “mS/m/1 wt %-SiO₂” denotes the value obtained by measuring the conductivity of each colloidal silica using a conductivity meter and dividing the measured value by silica concentration.

TABLE 1

| | C-1 | C-2 | C-3 |
|---|---|---|---|
| Colloidal silica raw material-A (kg) | 17 | 17 | 17 |
| Additive-A (kg) | 0.05 | 0.01 | 0.017 |
| Additive-B (kg) | 0.22 | 0.22 | 0.33 |
| Average diameter (nm) | 15 | 15 | 15 |
| Silica concentration (wt %) | 30 | 30 | 30 |
| Total Na concentration (ppm/SiO₂) | 13 | 13 | 13 |
| Conductivity (mS/m/1 wt %-SiO₂) | 19 | 20 | 26 |
| pH | 10.2 | 10.2 | 10.3 |

### (5) Polishing Test for Semiconductor Wafer Edge

The colloidal silica shown in Table 1 was diluted with pure water to obtain the silica concentration shown in Table 2 below. The following polishing test was performed using the resulting dilute colloidal silica. The results are shown in Table 2.

### Polishing Test

In accordance with the method described above, polishing test was performed using an 8-inch silicon wafer having a poly-Si film. The wafer edge polishing machine used and polishing conditions were as follows:

Polishing machine: EPD-200X edge polisher, manufactured by SPEEDFAM Co., Ltd.

Wafer rotating speed: 2,000 rpm,

Polishing duration: 60 sec/wafer,

Polishing composition flow rate: 3 L/min,

Polishing cloth: “SUBA400” (manufactured by NITTA HAAS Inc.),

Load: 40 N/unit.

Ten wafers were polished continuously and the tenth wafer was subjected to the following evaluation.

### Evaluation

After the edge was polished, pure water was supplied in place of the polishing composition so as to wash it out. The wafer was removed from the polishing machine and was subjected to the brush-scrub cleaning using 1 wt % ammonium aqueous solution and pure water. After that, the wafer was spin-dried while N₂ gas was blown. For the wafer thus obtained, the number of particles having a diameter of 0.15 μm or more adhered to the surface of the wafer was counted by SEM and a laser scattering surface diagnosis meter. Further, the presence or absence of haze and pit on the polished surface and also the presence or absence of unpolished portion caused by incomplete edge polishing were evaluated by eye-observation under the illumination of a converging lamp, and furthermore observed under the light microscope at a magnification of 800. The observation was conducted over the entire circumference of the work. Still further, the polishing speed was estimated from the weight difference of the device wafer before and after polishing.

### (6) Polishing Test for Surface Portion of Semiconductor Wafer

The colloidal silica shown in Table 1 was diluted with pure water to the silica concentration shown in Table 3. The following polishing test was performed using the resulting dilute colloidal silica. The results are shown in Table 3.

In accordance with the method described above, polishing test was performed using, as a silicon wafer, a conductive p-type 8-inch etched silicon wafer that was produced by the CZ method and had a resistivity of 0.01 Ω·cm and (100) crystal orientation. The wafer polishing machine used and mirror-polishing conditions were as follows:

Polishing machine: SH-24, manufactured by SPEEDFAM Co., Ltd.,

Surface table rotating speed: 70 rpm,

Pressure plate rotating speed: 50 rpm,

Polishing cloth: “SUBA400” (manufactured by NITTA HAAS Inc.),

Load: 150 g/cm²,

Polishing composition flow rate: 80 mL/min,

Polishing duration: 10 minutes.

### Evaluation

After the surface was polished, pure water was supplied in place of the polishing composition so as to wash it out. The wafer was removed from the polishing machine and was subjected to the brush-scrub cleaning with 1 wt % ammonium aqueous solution and pure water. After that, the wafer was spin-dried while N₂ gas was blown. The number of particles having a diameter of 0.15 μm or more adhered to the surface of the wafer thus obtained was counted by SEM and a laser scattering surface diagnosis meter. Further, the presence or absence of haze and pit on the polished surface was evaluated by eye-observation under the illumination of a converging lamp. Still further, the polishing speed was estimated from the weight difference of the device wafer before and after polishing.

### COMPARATIVE EXAMPLE

To 128 kg of conventional sodium-stabilized colloidal silica (“SILICADOL-40”: 40.4 wt % of silica concentration, 18 nm of average particle diameter, and 4,000 ppm of sodium content), 3333 g of the aforementioned additive-B were added. The resulting solution was stirred for 24 hours so as to prepare a colloidal silica having a pH buffer action, a silica concentration of 39 wt %, and a pH of 10.4 that served as a polishing composition (colloidal silica D-1). The polishing composition had a conductivity of 691 mS/m. The conductivity divided by silica concentration was 17.7 mS/m/1%-SiO₂. The polishing composition was subjected to polishing test similarly to Example. The results are shown in Tables 2 and 3.

TABLE 2

| | | | | | | | | | | D-1 |
|---|---|---|---|---|---|---|---|---|---|---|
| Abrasive | C-1 | C-1 | C-1 | C-2 | C-2 | C-2 | C-3 | C-3 | C-3 | (Comp. Ex.) |
| Silica concentration | 2 | 4 | 6 | 2 | 4 | 6 | 1 | 3 | 5 | 4 |
| (wt %) | | | | | | | | | | |
| Number of particles left | 9 | 13 | 11 | 7 | 12 | 14 | 4 | 8 | 9 | 700 |
| behind on wafer surface | | | | | | | | | | |
| (particles/wafer) | | | | | | | | | | |
| Pit and Haze on polished | no | no | no | no | no | no | no | no | no | no |
| surface | | | | | | | | | | |
| Unpolished portion | no | no | no | no | no | no | no | no | no | no |
| Polishing speed | 6.8 | 8.0 | 10.9 | 7.3 | 9.1 | 11.1 | 7.1 | 9.2 | 12.3 | 12.0 |
| (mg/min) | | | | | | | | | | |

TABLE 3

| | | | | | | | | D-1 |
|---|---|---|---|---|---|---|---|---|
| Abrasive | C-1 | C-1 | C-2 | C-2 | C-3 | C-3 | C-3 | (Comp. Ex.) |
| Silica concentration | 2 | 4 | 2 | 4 | 1 | 2 | 4 | 4 |
| (wt %) | | | | | | | | |
| Number of particles left | 4 | 8 | 7 | 7 | 3 | 8 | 11 | 580 |
| behind on wafer surface | | | | | | | | |
| (particles/wafer) | | | | | | | | |
| Pit and Haze on polished | no | no | no | no | no | no | no | no |
| surface | | | | | | | | |
| Polishing speed | 0.21 | 0.26 | 0.27 | 0.30 | 0.22 | 0.28 | 0.33 | 0.39 |
| (μm/min) | | | | | | | | |

As is clear from the results shown in Tables 2 and 3, in the polishing test in which the edge was polished with circulating the polishing composition (a products of the present invention) free of sodium, and in the mirror polishing test of the surface, the number of particles left behind on the polished surface was extremely small, and both adequate polishing speed and edge surface state were attained and they were favorable. To the contrary, as shown in the comparative example, in the case of the polishing composition used without sodium removal, the number of particles left behind on the polished surface was large, and thus defective effects on the semiconductor performance was expected.

1. A polishing composition for a semiconductor wafer comprising:
a colloidal silica being stabilized with a quaternary ammonium base that is prepared from a quaternary ammonium base and an active silicic acid aqueous solution obtained by removing alkali from an alkali silicate aqueous solution; and
a buffer solution which is a combination of a weak acid having a pKa that is a logarithm of a reciprocal of acid dissociation constant of from 8.0 to 12.5 at 25° C. and a quaternary ammonium base,
wherein the polishing composition contains substantially no alkali metals, and has a buffer action at 25° C. in the range from pH8 to pH11.

2. The polishing composition for a semiconductor wafer according to claim 1, wherein the colloidal silica stabilized with a quaternary ammonium base contains non-spherical silica particles.

3. The polishing composition for a semiconductor wafer according to claim 1, wherein the polishing composition is a water dispersion having a silica concentration from 2 to 50% by weight with respect to a total amount of a colloidal solution.

4. The polishing composition for a semiconductor wafer according to claim 1, having a conductivity at 25° C. of 15 mS/m or more based on 1% by weight of silica particles.

5. The polishing composition for a semiconductor wafer according to claim 4, wherein the polishing composition has a salt of a strong acid and a quaternary ammonium base so as to adjust the conductivity at 25° C. of 15 mS/m or more based on 1% by weight of silica particles.

6. The polishing composition for a semiconductor wafer according to claim 5, wherein the salt of a strong acid and a quaternary ammonium base is a quaternary ammonium sulfate, a quaternary ammonium nitrate, or a quaternary ammonium fluoride.

7. The polishing composition for a semiconductor wafer according to claim 1, wherein an anion constituting the weak acid is a carbonate ion and/or a hydrogen carbonate ion; and the quaternary ammonium base is a choline ion, a tetramethylammonium ion or a tetraethylammonium ion, or a mixture thereof.

8. The polishing composition for a semiconductor wafer according to claim 1, wherein an average diameter of silica particles of the colloidal silica by a BET method is from 10 to 200 nm.

9. A method for producing the polishing composition for a semiconductor wafer according to claim 1, comprising the steps of:
preparing the active silicic acid aqueous solution by contacting dilute sodium silicate with a cation exchange resin to remove sodium ions;
allowing to grow colloidal particles by adding the quaternary ammonium base to adjust the pH in the range from 8 to 11 followed by heating the active silicic acid aqueous solution;
preparing the colloidal silica which is free of alkali metals and has a silica concentration from 10 to 60 wt % by concentrating silica with ultrafiltration; and
adding the weak acid and the quaternary ammonium base to the colloidal silica to make a buffer composition and to adjust the silica concentration in the range from 2 to 50 wt %.

10. A polishing method comprising:
rotating a rotatable polishing plate and/or a semiconductor wafer while the polishing composition according to claim 1 is supplied to the polishing plate to polish a surface of the semiconductor wafer using the polishing plate having a polishing cloth fixed to both or either of its upper and lower face, under a state of pressing the semiconductor wafer against the polishing plate.

11. A polishing method comprising:
polishing an edge of a semiconductor wafer using a drum-shaped polishing member having a polishing cloth fixed to its surface or with a polishing apparatus having a polishing member with an arc-shaped working surface, wherein the polishing member and/or a semiconductor wafer are rotated while the polishing composition according to claim 1 is supplied to the polishing member, under a state of the edge of the semiconductor wafer being pressed against the polishing member.
